(19) United States
(12) Patent Application Publication
(10) Pub. No.: US 2002/0074404 A1
(43) Pub. Date: Jun. 20, 2002

(54) Portable bar code simulator device and method

(76) Inventor: Donald E. Drumm, Billerica, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/966,031

(22) Filed: Sep. 28, 2001

Related U.S. Application Data
(60) Provisional application No. 60/236,220, filed on Sep. 28, 2000.
(60) Provisional application No. 60/289,739, filed on May 9, 2001.

(51) Int. Cl. G06K 7/10

(52) U.S. Cl. 235/462.01

(57) ABSTRACT

A method and device are provided that simulate the back-scattered light patterns reflected from the surface of a bar code when a bar code scanner passes a pulse of light across its surface. The bar code simulator includes a detector for detecting the presence of a bar code scanner and a light source for emitting a sequence of light patterns simulating light reflected from a bar code. The bar code simulator includes circuitry to detect operating characteristics of bar code scanners and of the environment such that the bar code simulator functions properly with any variety of bar code scanners and is tolerant of operator and environment.

### RELATED APPLICATIONS

This application claims priority under 35 U.S.C. §119(e) to commonly-owned, co-pending U.S. Provisional Patent Application Serial No. 60/236,220 entitled, “Portable Bar Code Simulator Method, Device and Electronic Coupon Device,” filed Sep. 28, 2000, and U.S. Provisional Patent Application Serial No. 60/289,739 entitled, “Portable Bar Code Simulator Method and Device,” filed May 9, 2001, which are hereby incorporated by reference in their entirety.

### BACKGROUND OF THE INVENTION

1. Field of the Invention

This disclosure is directed towards a method and device for generating a signal that emulates the pattern of light reflected from a bar code when a pulse of light from a bar code scanner is swept across the bar code, and, in particular, to a device that communicates with bar code scanners without the physical printed barcode.

2. Description of the Related Art

Bar codes have been in use for many years and have become the standard for efficient and inexpensive coding and transfer of small amounts of data. The Universal Product Code (UPC), a bar code symbology standard, has become an indispensable merchandising system to identify manufacturers and products. There are many bar code standards available including the UPC, the European Article Number (EAN), Code 39, Code 93, ISBN, and ISSN to name a few. Each standard has a specific symbology to code information, but every standard functions on the same basic bar and space premise. A bar code is comprised of a series of alternating black bars and white spaces of varying widths. Each bar and a space will have a minimum width that can be treated as the unit width for a bar and a space, respectively. At least one bar and one space of respective unit width typically appear at the beginning of each bar code sequence for proper calibration. Successive bar and spaces in a coded sequence will have widths that are integer multiples of the unit width and the bar code information is coded by the pattern of varying widths in a sequence of alternating bars and spaces. The bar code sequence can be printed on a medium and affixed to a product or item for identification.

The bar code can be read and decoded by a bar code scanner signal that passes a pulse of light over a printed bar code and detects the back-scattered light patterns reflected by the bar code. A bar will absorb a large portion of the scanner signal while a space will reflect a large portion of the scanner signal. The durations of the absorption and reflectance patterns gathered by the scanner as back-scattering of the scanner signal corresponds to the widths of the corresponding bars and spaces of the bar code. In this way, the coded information is transferred from the printed bar code to the scanner. All bar code standards operate in this fashion.

Bar codes have been used extensively by the retail and merchant industries in consumer applications such as coupon distribution and product discount identification. Coupons are distributed in magazines, newspapers, and coupon books and include the bar code identification of the discounted product. The coupon is scanned at a point-of-sale terminal in conjunction with the product and the discount is deducted from the purchase. However, the physical coupon must be present at the time of the purchase in order to enact the discount. This is often inconvenient as coupons are clumsy to transport, and may be lost, misplaced, destroyed or forgotten. Furthermore, for customers with numerous coupons, the coupons can become difficult to organize, confusing to determine what discounts are available, awkward to locate the proper coupons and time consuming to process at a point-of-sale terminal.

Smart card technology incorporates semiconductor advances by embedding a micro-chip in a credit card sized piece of plastic. The microprocessors contained in the smart cards can store many times more information than can the standard magnetic strip, as well as perform computations and make decisions. For more than a decade smart card technology has been in use, particularly in Europe. In the United States, the adoption of the technology has been severely lagging due largely to the lack of an infrastructure to read and process smart cards. An investment of money and equipment is needed to establish terminals, merchant processing systems, and card life cycle management systems, which has been a bottle-neck in deploying the advantages of smart card technology. However, in the retail and merchant industries bar code scanning is ubiquitous and an infrastructure is already in place.

Because a bar code is passive and static, there has been no need to standardize the bar code scanner itself. Different manufacturers have designed scanners to solve the problems of locating, reading and decoding bar codes in a variety of different ways. As a result, scanners on the market may have different design parameters and operating characteristics including variations in scan speed of the pulse of the scanner signal, repetition frequency of the pulse, frequency of the emitted light beam, and whether the beam is pulsed uni-directionally or bi-directionally.

Prior devices, such as disclosed in U.S. Pat. No. 4,736,096 and U.S. Pat. No. 5,760,383 have been proposed to simulate back-scattered light patterns reflected by a printed bar code. However, the bar code simulating device as disclosed in U.S. Pat. No. 5,760,383 is disclosed as for use in testing of bar code scanners, wherein the design parameters and operating characteristics and environment are known a priori.

### SUMMARY OF THE INVENTION

It is therefore convenient and desirable to be able to redeem product coupons without needing to produce the physical printed bar code at a point-of-sale terminal. It is desirable to leverage smart card technology by exploiting existing bar code scanning infrastructure. It is desirable to have a universal bar code simulator that functions properly with any variety of bar code scanners and is tolerant of operator and environment.

The present invention provides a method and device for generating a signal that simulates a reflected pattern of a bar code scanner from a bar code. Some embodiments of the bar code simulator of the present invention work with a wide range of scanners having a variety of design parameters and operating characteristics. Furthermore, some embodiments of the bar code simulator of the present invention adapt to the environment and operating conditions and imprecision of a bar code scanner operator.

In accordance with some embodiments of the present invention, the bar code simulator device comprises a light source that emits a sequence of first and second states representing the reflection characteristics of bars and spaces in a bar code, respectively. The EBCS further comprises a driver to drive the light source according to the pattern sequence. In one aspect of the invention the EBCS includes detection circuitry to detect the speed of a scanner signal. In another aspect of the invention the EBCS device further comprises detection circuitry to determine whether a scanner is of the uni-directional or bi-directional type.

In one aspect of some embodiments of the invention the EBCS detects ambient light and scanner signal intensity in order to adjust the gain on the detector. Another aspect of some embodiments of the invention is to provide a bar code simulator that has a high detector area to aperture ratio to allow for non-critical alignment of the scanner with the bar code simulator as well as providing a signal that most closely resembles the appearance of back-scattered light reflected from a bar code.

In accordance with some embodiments of the present invention, there is provided a solution to some problems of printed bar code distribution, storage, and organization, by providing an electronic bar code simulator and storage device.

In accordance with some embodiments of the present invention, a smart card technology is mated with the existing bar code scanning infrastructure, by providing a device to read smart cards and communicate stored bar code information.

These and other features and advantages will be more clearly understood from the following detailed description in conjunction with the accompanying drawings. It is important to note the drawings are not intended to represent the only form of the invention.

### BRIEF DESCRIPTION OF THE DRAWINGS

FIG. 1 illustrates a block diagram of one embodiment of an Electronic Bar Code Simulator (EBCS) device, according to this disclosure;

FIG. 2A, 2B illustrate side and front views respectively of components of an embodiment of the EBCS device;

FIG. 3 illustrates an embodiment of a light pipe arrangement that focuses light on a photo-detector, according to this disclosure;

FIG. 4A, 4B illustrate side and top views respectively of some components of an embodiment of the EBCS;

FIG. 5a illustrates exemplary pulses of a detected bar code scanner signal from four scanners that exhibit different scan speeds;

FIG. 5b illustrates exemplary simulated bar code signals emitted at two different rates;

FIG. 6 illustrates a timing diagram between pulses of a detected bar code scanner signal and a simulated bar code signal according to an embodiment of the EBCS device;

FIG. 7a illustrates a photo-detector augmented with a light pipe comprising two halves with different opacities to provide a detected bar code scanner step signal according to an embodiment of a EBCS;

FIG. 7b illustrates a detected bar code scanner step signal provided in response to a scanner of a uni-directional type;

FIG. 7c illustrates a detected bar code scanner step signal provided in response to a scanner of the bi-directional type.

FIG. 8A illustrates exemplary pulses of a detected bar code scanner signal in response to a scanner of bi-directional type, including expanded portions of a pulse sequence to illustrate a temporal order between signals produced by two detectors for an embodiment of the EBCS;

FIG. 8B illustrates exemplary pulses of a detected bar code scanner signal in response to a scanner of uni-directional type, including expanded portions of a pulse sequence to illustrate a temporal order between signals produced by two detectors for an embodiment of the EBCS;

FIG. 9 illustrates one embodiment of a method of storing sequences in memory to simulate light reflected from a bar code by a bar code scanner operating in uni-directional and bi-directional modes of operation;

FIG. 10 illustrates exemplary output drive signal and check signals for respective fast clocking and slow clocking, for an embodiment of the EBCS;

FIG. 11 illustrates a schematic diagram of an embodiment of the EBCS;

FIG. 12 illustrates another schematic diagram of an embodiment of the EBCS comprising a docking station, according to an embodiment of EBCS;

FIG. 13 illustrates an embodiment of an electronic coupon holder device including an embodiment of the EBCS device;

FIG. 14 illustrates an exemplary form factor for an embodiment of the EBCS device; and

FIG. 15 illustrates an embodiment of a smart card to bar code simulator device.

### DETAILED DESCRIPTION

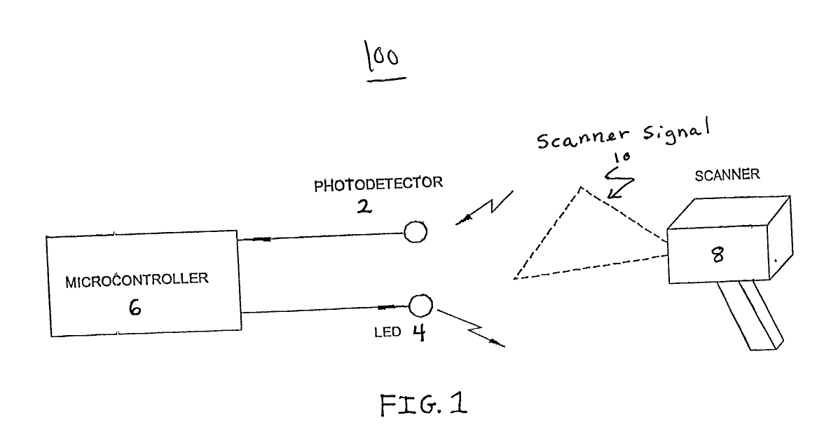

FIG. 1 illustrates a block diagram of one embodiment of an electronic bar code simulator (EBCS) device 100 according to the present invention. The bar code simulator comprises a photo detector 2 and a light source 4 coupled to a microcontroller 6. The photo detector may be any applicable type of photo detector, such as a photo diode or a photo transistor, that can detect light in an applicable frequency band of a bar code scanner 8, such as infrared (IR), visible, or both. The photo detector detects a scanning signal 10 emitted from the bar code scanner.

The microcontroller 6 coordinates the activities of determining when the bar code scanner signal has been detected and simulating the bar code signal. It is to be understood that the EBCS device 100 comprises the microcontroller 6 coupled to the photo detector 2 and the LED 4, and is configured to coordinate activities of the EBCS device. The microcontroller can be configured to provide the emitted signal upon detection of a bar code scanner, and to drive the LED with a bar code pattern sequence of a simulated bar code signal. According to some embodiments of the bar code simulating device, a detected scanning signal from a bar code scanner initiates a process of generating simulated back-scattered light patterns reflected from a printed bar code. The simulated signal is generated by modulating the light source to correspond to a bar and space pattern of a bar code. When the light source is emitting light, i.e., when it is in an “ON” state, the emitted light corresponds to a space in the bar code by mimicking a high level of light reflected by the white space of the bar code. When the light source is not emitting light, i.e., when it is in an “OFF” state, it corresponds to a bar in the bar code by mimicking a low level of light reflected by the black bars of the bar code. The light source is modulated “ON” or “OFF” for a predetermined duration or period that corresponds to a width of a particular space or bar, respectively. A temporal coded sequence of “ON” and “OFF” states can be provided to emulate the reflection pattern of a bar code, and can be provided to the bar code scanner's detection mechanism in a manner indistinguishable from a printed bar code.

It is to be understood that more than one light source may be used to simulate a bar code in more than one frequency band, e.g., IR, visible, or both. In addition, the light detector and light source should be spectrally capable of detecting and emitting light at the known wavelength of scanners. This may be one or both of IR or visible light frequency bands.

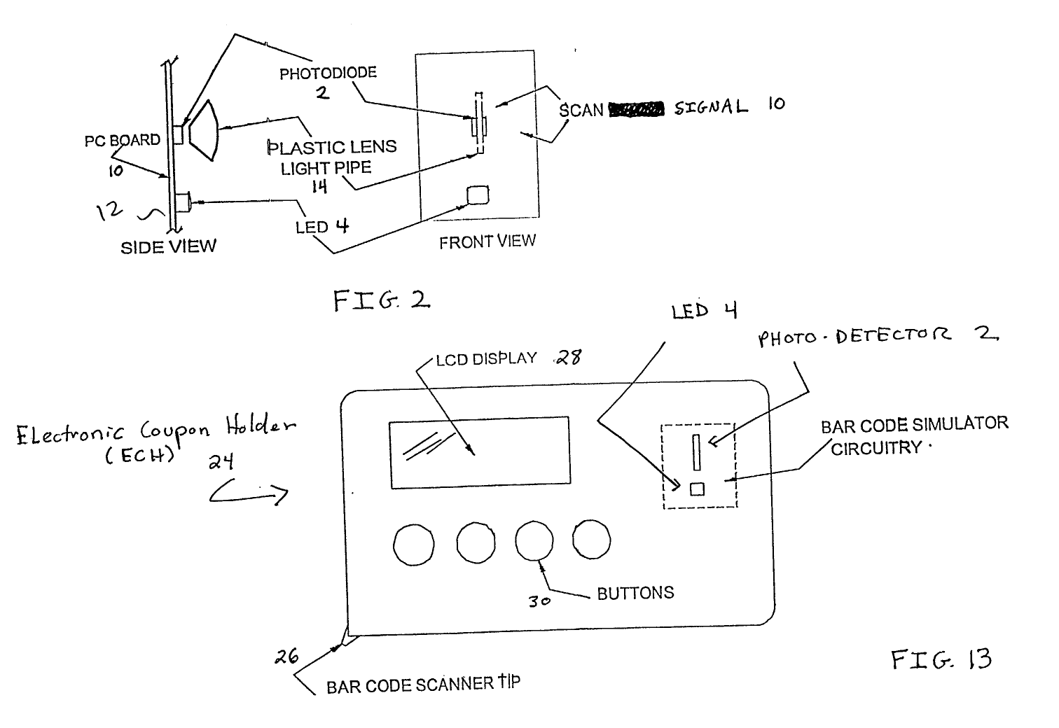

FIG. 2 illustrates some components of an EBCS device according to some embodiments of the present invention. A photo-diode 2 and an LED 4 (Light Emitting Diode LED) are affixed to a printer circuit board 12 in close proximity to one another and in vertical alignment. In this way, the photo-diode and the LED appear at substantially a same moment along a time axis with respect to a scanner signal traversing the EBCS device. The photo-diode can be any suitable photo-sensitive element that responds to light in the frequency spectrum of known bar code scanners. In one embodiment the LED is a wide angle point source without any lens molded into the package. The wide angle LED can provide the simulated signal over a sufficient angle to closely match an “appearance” of back-scattered light reflected from a printed bar code. In addition, a light pipe 14, or any suitable single axis lens can be light coupled to the photo-diode with an axis orthogonal to an axis traversed by a scanner signal. A plastic single axis light pipe is illustrated in FIG. 2, however, it is to be appreciated that a light pipe of glass, fiber optic material, or any other material suitable for collecting and focusing light along at least one axis may be used. One advantage of an EBCS device having a lens, is that the lens provides an extended detector target area along an axis orthogonal to a direction a scanner signal traverses, which obviates any need for operator precision of focusing the scanning device on the photo detector, and allows for non-critical alignment between the bar code simulator device and the scanner.

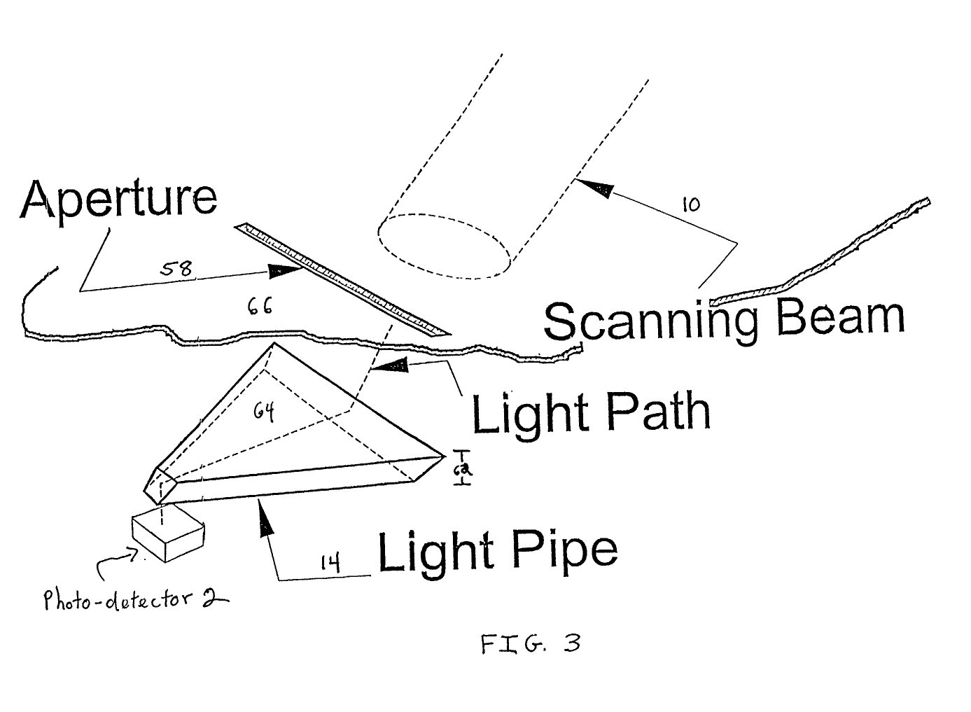

In some embodiments of the EBCS device, it may be desirable to construct the lens with a small vertical height to reduce the chances of it being accidentally damaged or broken off. FIG. 3 illustrates one embodiment of a light pipe 14 with a small vertical height. The light pipe is a substantially flat prism. The height of the prism 62 reduces the height with which it protrudes from the EBCS device and has a flat surface 64 making it less vulnerable to damage during transport and use. In some embodiments, the light pipe and the photo-detector are constructed below a protective surface 66 to further prevent damage to the ECBS components. An aperture 58 in the protective surface allows light from a scanner to penetrate through to the light pipe, which in turn focuses the light on the photo-detector 2.

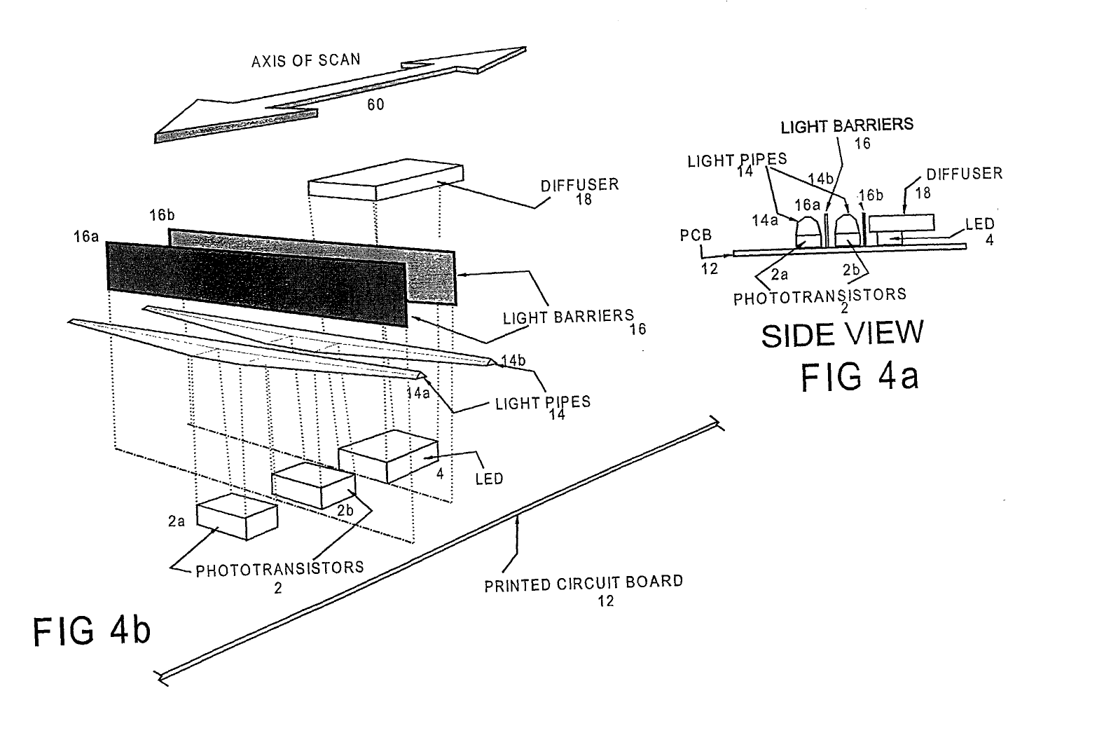

FIG. 4A and 4B illustrate exploded and side views of an arrangement of optical components according to some embodiments of the EBCS device 100 of the present invention. The exploded view of FIG. 4A illustrates how the components are configured and arranged relative to each other and with respect to an axis of scan 60 of a scanner signal. Two photo detectors 2a, 2b are affixed in horizontal alignment and as close together as feasible. The photo detectors can be similarly augmented with a light pipes 14a, 14b. Additionally, a light barrier 16a can be placed between the photo detectors to improve isolation and prevent cross-talk between the neighboring photo detectors. A light barrier 16b may also be placed between the photo detectors and the LED to prevent the photo detectors from sensing the emitted bar code signal and generating erroneous detected scanner signals. In some embodiments as illustrated in FIG. 4b, the LED 4 can be placed in horizontal alignment with the photo-transistors and provided with a light diffuser 18 such that a light signal emitted by the LED mimics back-scattered light patterns reflected from the surface of a printed bar code.

In another embodiment of an EBCS device 100, at least one additional LED (not shown) is placed in horizontal alignment with the first LED 4 and placed as close together as feasible in order to enlarge an emitting region of the bar code simulator device. This arrangement allows for less critical timing between the emitted signal by the EBCS device and detection of a scanning pulse of a bar code scanner. Furthermore, it is to be appreciated that additional LEDs may be provided that emit light in different frequency bands, i.e., the infrared (IR) and visible spectrum. Furthermore, the photo-detectors 2a and 2b may be provided such that they detect light in different frequency bands, i.e., the IR and visible spectrum. With this arrangement, detection circuitry (not shown) discussed in detail infra, may also be coupled to the photo-detectors to monitor the signals produced in response to a scanner signal. The presence of a detected scanner signal from, for example, photo-detector 2a and not from photo-detector 2b would indicate that the scanner signal is being emitted in the frequency band of photo-detector 2a. Likewise, the presence of a detected scanner signal from photo-detector 2b and not from 2a would indicate that the scanner signal is being emitted in the frequency band of photo-detector 2b. Thus, the detection circuitry monitoring the detected scanner signals may accordingly direct the LEDs in the corresponding frequency band to emit the simulated bar code signal. In the presence of a detected scanner signal from both photo-detectors 2a and 2b, the circuitry may direct the LED in the frequency band corresponding to the strongest of the two detected scanner signals to emit the simulated bar code signal.

As will be discussed in further detail infra, it is to be appreciated that in some embodiments of the EBCS device, the components described herein may be disposed in any suitable arrangement on a light absorbing area, such as, a black background or a surface with a uniform matte finish, in order to suppress spurious specularities and reflections that may be detected erroneously by the bar code scanner.

It is to be appreciated that the illustrated bar code simulator components shown in FIGS. 2,3, 4a, and 4b and according to several embodiments are illustrative and not limiting. There may be various modifications, improvements and alternatives apparent to one of skill in the art and improvements, and these are intended to be within the scope and spirit of the invention.

According to some embodiments of an EBCS device of the present invention, the EBCS device may detect operating characteristics and conditions of a scanner so that the EBCS device can function with different commercially available scanners. According to these embodiments, several operating characteristics of a scanner can be determined and the signal emitted by the bar code simulator device can be adjusted accordingly. One such operating characteristic is a speed with which a scanner sweeps a pulse of the light signal across the bar code simulator device. This speed can be detected so that a “size” of the emitted signal provided by the EBCS device, i.e., the duration of each “ON” and “OFF” state in a simulated bar code sequence can be provided to match the scan speed. For example, a scanner with a high scan speed, will pass a pulse of the scanner signal over the bar code simulator device rapidly, which should result in a reflection pattern with reflection and absorption durations that are very brief. Thus, a “size” of a reflected signal should be squeezed within a short time period. Accordingly, the simulated bar code signal should have shortened durations of “ON” and “OFF” states in a sequence in order to emulate the reflected signal from a bar code. Likewise, in the presence of a scanner with a slow scan speed, the durations of the “ON” and “OFF” states should be lengthened.

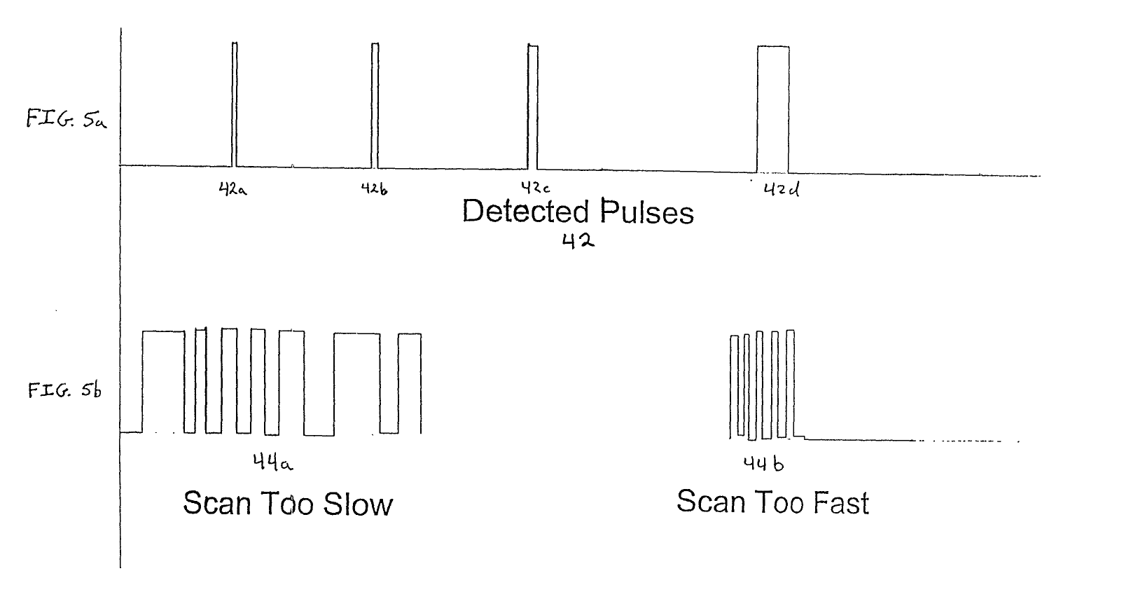

FIGS. 5a and 5b illustrate exemplary timing diagrams showing problems that can occur when the “size” of the simulated bar code signal does not match the speed of the bar code scanner signal. A photo-detector will provide a pulse shaped detected bar code signal in response to a bar code scanner passing a signal across it. FIG. 5a shows a detected bar code signal comprising a series of pulses provided by a photo-detector in response to four bar code scanners of different speeds. It is to be understood that the detected pulses 42a-d resulting from scanners of different speeds appear together as shown in FIG. 5a for illustration purposes only. Detected Pulse 42a results from detection of a scanner with a high scan speed. Detected Pulse 42d results from detection of a scanner with a slow scan speed. Detected pulses 42b and 42c result from different intermediate speed scanners.

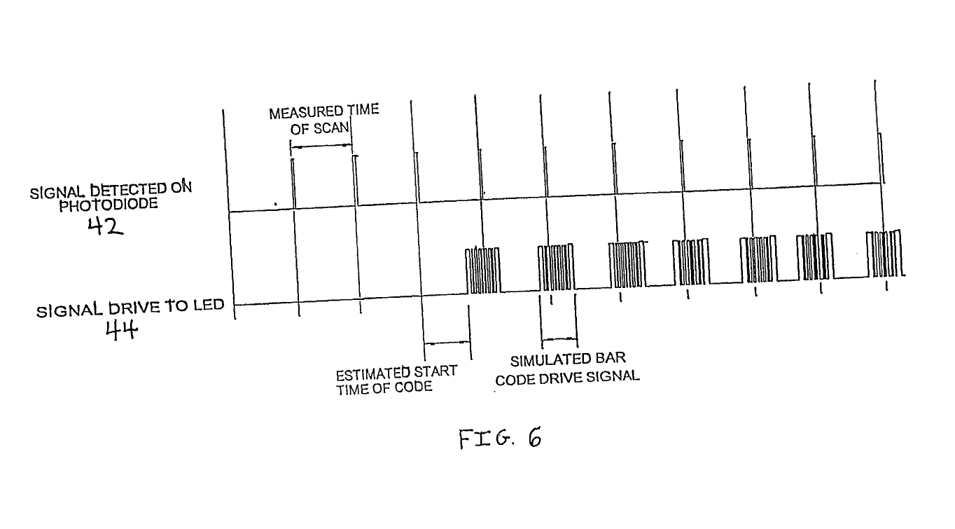

FIG. 5b schematically illustrates two simulated bar code signals of different “sizes”. Simulated signal 44a illustrates a sequence of “ON” and “OFF” states in which the durations have been lengthened. Simulated signal 44b illustrates a sequence in which the durations have been shortened. A mismatch problem can occur when the simulated signal is emitted too slowly for a scanner with a higher scanning speed. This problem is depicted by the simulated signal 44a of FIG. 5b. While the signal 44a is being simulated, two pulses 42a,b are generated in response to the detection of a scanner signal. In this illustrated example, the scanner will misinterpret the simulated signal 44a as two separate signals and the information will be erroneously transferred from the EBCS to the scanner. The simulated signal should be completed before a subsequent pulse is detected. Another mismatch problem occurs when a bar code signal is simulated too rapidly for a scanner to properly interpret. This problem is depicted by simulated signal 44b of FIG. 6b. Simulated signal 44b is nearly complete while the photo-detector is still responding to a scanner signal and can lead to a scanner missing any number of a “ON” and “OFF” states that were emitted in too rapid a succession, resulting in information being lost. Accordingly, the simulated signal should also have “ON” and “OFF” states of sufficient length that they are detectable by the bar code scanner.

FIG. 6 illustrates a simulated bar code signal where the “size” of the signal is matched to the speed of the scanner, as provided according to some embodiments of the EBCS device of the invention. Detected scanner signal 42 comprises a plurality of pulses provided by a photo-detector (not shown) in response to a bar code scanner passing a pulse of a scanner signal across the EBCS device. Simulated bar code signals 44a-g are emitted in response to the detected scanner signal. It should be appreciated that the simulated bar code signal completes its sequence before the detection of a subsequent pulse and is also wide enough as compared to the width of a detected pulse to be detected by the scanner providing the scanner signal. Thus, the problems as illustrated in FIGS. 55a and 5b are avoided.

It should be appreciated that according to some embodiments of the EBCS device of the invention, the speed of a scanner is determined first as described herein in order to adjust the “size” of the simulated signal so that neither of the above illustrated problems arise. According to some embodiments, a width of a pulse of a detected bar code scanner signal from a single photo-detector is measured to determine the scan speed of a scanner. As illustrated in FIG. 5a, the pulse width of a detected bar code scanner signal will be proportional to the speed of the scanner signal. Thus, the width of these detected pulses is measured to determine the scan speed of a particular scanner and the “size” of a simulated signal emitted by the EBCS is adjusted accordingly.

In some embodiments of the EBCS device, the scan speed can be detected by including two photo-detectors 2a, 2b disposed along side one another as shown in FIG. 4b. With this arrangement, an interval between detection of a scanner signal by the first photo-detector and detection of the scanner signal by the second photo-detector can be measured to determine the speed at which a scanner sweeps its signal across the EBCS device. The “size” of the simulated bar code signal emitted by the EBCS device is adjusted accordingly to match the scan speed. Thus, some embodiments of the EBCS device of the invention can modify the emitted bar code signal in response to operating characteristics of the scanner, allowing the device to function properly with scanners having widely different scan speeds.

According to some embodiments of the EBCS device of the invention, the EBCS device aligns the emitted signal with the detected pulse of the scanner signal. By emitting a simulated bar code signal just as the scanner signal is passing over the EBCS device, the EBCS device can provide the simulated bar codes signal to scanners with small reflected signal detection areas and the simulated bar code signal can be emitted coincident with the detected scanner signal.

FIG. 6 also illustrates exemplary pattern sequences provided by some embodiments of the EBCS device, wherein the EBCS device centers the simulated signal with the pulse detected by the photo-detectors by predicting a time of arrival of the next pulse of the scanner signal. Some embodiments of the bar code simulator device measure an interval between successive pulses of the scanner signal, and estimate a time of arrival or detection of the next scanner signal pulse. The EBCS device measures the time between successive detected scanner pulses and determines when it should begin emitting the simulated bar code signal such that the signal is provided as the scan beam passes over the EBCS device, and also such that the emitted signal is substantially half way through its pattern sequence as the next scanner signal is detected, thus centering the emitted bar code signal with the detected scanner pulse. With this arrangement, some embodiments of the EBCS device align the emitted bar code signal with the detected pulse of the scanner signal to provide the simulated signal to the scanner when it is expected, i.e., during the interval of only one pulse of the scanner. Thus, by centering the emitted bar code signal on the detected scanner pulse, the EBCS device can also prevent an emitted signal of the EBCS device from overlapping parts of an interval containing two successive detected pulses that can potentially cause the scanner to misinterpret the bar code signal as two separate signals resulting in erroneous reading of the data.

According to some embodiments of the EBCS device of the invention, the EBCS device determines a directionality of a scanner beam, i.e., whether the scanner device is uni-directional or bi-directional. Scanners can either pass a beam across a bar code uni-directional, wherein each successive pulse of the scanner signal traverses the bar code in a same direction, e.g., from left to right, or bi-directionally, wherein the scanner alternates the direction with which successive pulses traverse the bar code, e.g., one pulse traverses the bar code from left to right and a subsequent pulse traverses the bar code from right to left. Some embodiments of the EBCS device can detect a type of the scan beam and format the coded signal according to the type of scanner signal provided by the scanner. For example, the EBCS device can provide a simulated bar code signal sequence and the reverse of that sequence in alternation when a scanner is determined to be of the bi-directional types.

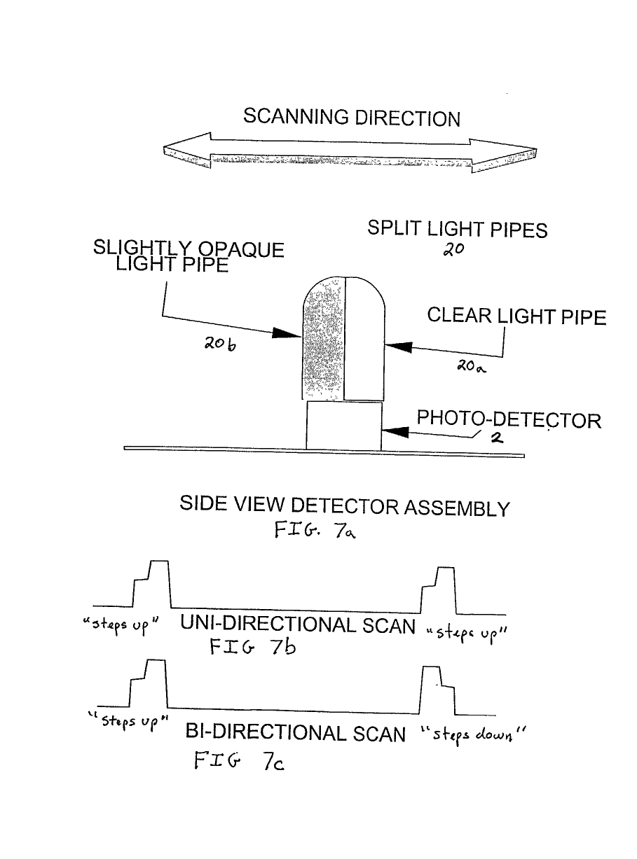

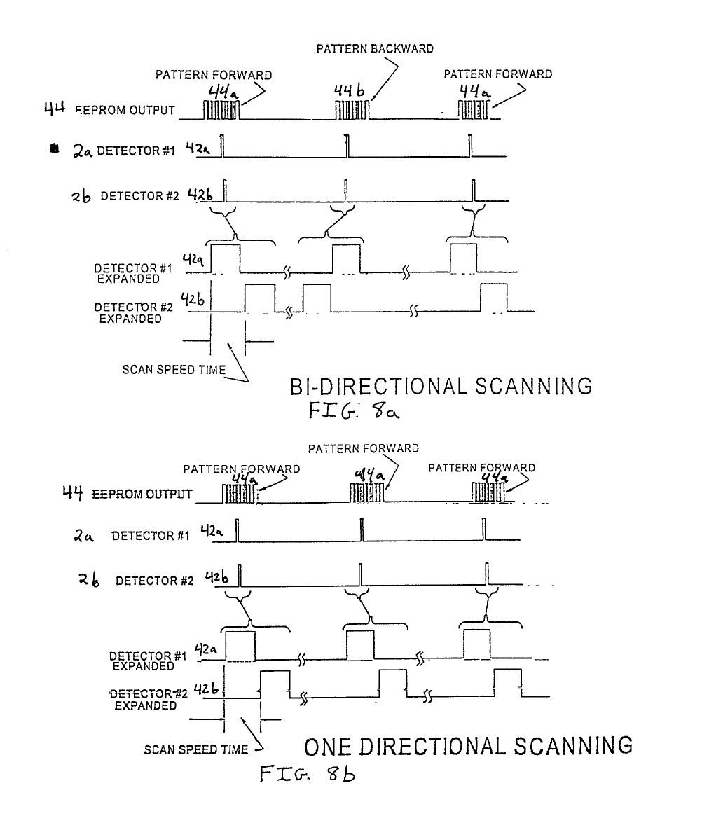

In some embodiments comprising the photo detector 2 as illustrated in FIG. 7a, the photo-detector 2 is light coupled to a split light pipe 20. The photo detector and the light pipe together can provide a detected signal that can be used to determine whether a scan beam is of the uni-directional or bi-directional type. The light pipe can comprise two halves 20a, 20b as illustrated in FIG. 7a. One half 20a can be constructed of a material that is highly transmissive, i.e., having low or no opacity. The other half 20b of the light pipe can be constructed of a material with a higher opacity. As illustrated in FIG. 7a, a slightly opaque half of the light pipe precedes a clear half of the light pipe with respect to a scanning signal traversing the photo detector from left to right. As a light beam passes over the photo-detector's target area in the scanning direction indicated, a step signal is produced by the photo-detector in response to the differing levels of light transmitted to the detector through the two halves of the light pipe. An exemplary signal produced by the photo-detector in response to a uni-directional scan beam that traverses the photo detector from left to right, is shown in FIG. 7b. The shape of the step signal “steps up” on each detected pulse of the scanner signal. The signal produced by the photo-detector in response to a scan beam provided by a bi-directional scanner that alternates between left to right and right to left is illustrated in FIG. 7c. The step signal alternates between a shape that “steps up” and “steps down” on subsequent pulses of the scanner signal. Detection circuitry can be coupled to the photo-detector to detect whether the response signal is above or below a particular threshold. The threshold can be set such that the detected bar code scanner signal (the step signal) is below the threshold when a scanner signal is over the half of the light pipe with higher opacity (opaque light pipe) and above the threshold when the scanner signal is over the half of the light pipe with the low opacity (clear light pipe). With this arrangement, the shape of the step signal generated by the photo-detector can be monitored by the EBCS device, i.e., to determine whether the detected scanner signal “steps up” or “steps down” on successive pulses of the scanner signal, so as to determine the direction that the scan beam is traversing the EBCS device so as to determine whether the scan beam is of the uni-directional or bi-directional type.

In one embodiment of the EBCS device, automatic gain control circuitry (not shown) is coupled to the photo-detector to vary a gain of the detected scanner signal. The automatic gain circuitry has a threshold value that is appropriately set such that the amplitude of detected scanner signal is above the threshold value when the scanner signal is over the half of the light pipe with the low opacity and the amplitude of the detected scanner signal is below the threshold value when the scanner signal is over the half of the light pipe with the higher opacity. With this arrangement, scanners that emit signals with different intensities can be detected as uni-directional or bi-directional.

In some embodiments of the EBCS device, detection circuitry coupled to the one or more photo-detectors measures the amount of ambient light in the operating environment. Automatic gain control circuitry is coupled to photo-detectors and automatically adjusts a gain applied to the detected scanner signal according to the amount of ambient light to be low enough so that ambient light does not appear as a bar code scanner signal and so to be simultaneously large enough so that scanner signals are not spuriously detected and are not missed in environments of differing ambient light characteristics. The automatic gain control can additionally be coupled to the driving circuit that drives the light source so as to adjust the intensity of the emitted bar code signal according to the amount of ambient light such that the emitted scanner signal can be distinguished from the ambient light environment, to accommodate the operation of scanners in environments having differing levels of ambient light.

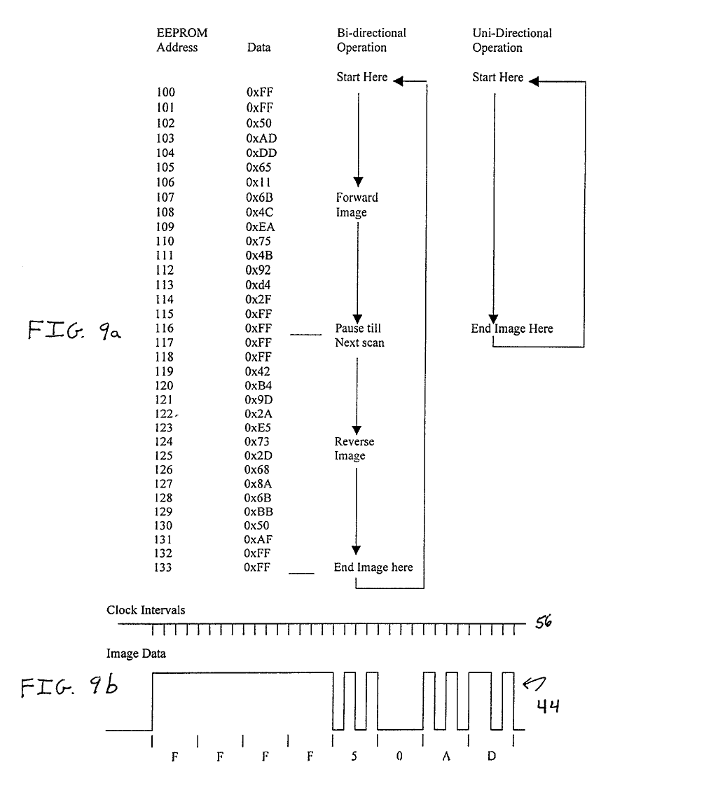

In embodiments of the EBCS device, the bar code simulator device comprises at least two photo-detectors disposed adjacent one another to determine whether the scanner signal emitted by the scanner is uni-directional or bi-directional. FIGS. 85a and 8b illustrate exemplary timing diagrams of the detected bar code scanner signals that may be provided by the EBCS device. For a uni-directional detected scanner signal as illustrated in FIG. 8b, each successive pulse of the scanner signal traverses the photo-detectors 2a,2b in a same direction such that, for example, photo-detector 2a will first detect the scanner signal pulse followed by detection of the scanner pulse by photo-detector 2b. This is illustrated by the pulses of the detected bar code scanner signal 42a and 42b in FIG. 8b that appear in the same temporal order on every pulse of the scanner signal. In contrast, for a bi-directional detected scanner signal as illustrated in FIG. 8a, successive pulses of the scanner signal alternate the direction in which they traverse the detectors such that the photo-detector to first detect the scanner signal will alternate on every pulse. This is illustrated by the pulses of the detected bar code scanner signal 42a and 42b in FIG. 8a that appear in alternating temporal order on each successive pulse of the scanner signal. With this arrangement, monitoring of the temporal order in which photo-detectors sense the scanner signal can be employed to determine whether a scanner beam is uni-directional or bi-directional.

It should be appreciated from FIGS. 8a and 8b and the foregoing description that when a scanner with a bi-directional scanner signal reads a bar code, the light reflection patterns responding to each successive pulse will be the reverse of one another. In other words, the scanner signal reflected from the barcode traversing from left to right will be the time-reverse of the scanner signal reflected from the bar code from right to left. Accordingly, some embodiments of the EBCS device, upon detection of a bi-directional scan beam, reverse the sequence of “ON” and “OFF” states on alternate emissions of the simulated bar code signal, such as illustrated in FIG. 8a. In other words, the signal generated to simulate a bar code for a scanner signal of the bi-directional type will alternate between the pattern sequence 42a and the reverse of the pattern sequence 42b, as indicated in FIG. 8a. In addition, some embodiments of the EBCS device, upon detection of a uni-directional type scanner signal, provide the signal to simulate a bar code comprising the forward pattern sequence 42 each time, as illustrated in FIG. 8b.

Some embodiments of the EBCS device further comprise a memory that stores bar code pattern sequences that can be used to generate the simulated bar code signals. FIGS. 9a and 9b illustrate one embodiment of a method by which an EEPROM (Electrically Erasable Programmable Read Only Memory) device stores and provides sequences of data corresponding to bar code patterns to be simulated. In particular, FIG. 9a illustrates one embodiment of a method for storing and providing a sequence of data and reversing the sequence of data to simulate a reflected bar code signal in response to a bi-directional scanner. It is to be appreciated that EEPROM devices are only one example of storage devices that can be used in storing data that is updated periodically and that can maintain stored data without power. Alternative storage devices can also be used and are intended to be within the scope of this disclosure. Nevertheless, EEPROM devices typically have simple mechanisms for clocking data in and clocking data out of the device. An address can be specified as a start point and the data read out by applying a clock pulse. Data from consecutive addresses are read out sequentially as long as the clock pulses are continually applied to the EEPROM device. Thus, an EEPROM device is well suited to reading out sequences representing bar code signals.

It is to be appreciated that FIG. 9a illustrates a snapshot of the data corresponding to one sequence of a bar code to be simulated by the EBCS device and how the data can be stored in the EEPROM device, according to one embodiment of the present invention. In the first column of FIG. 9a, the address of the EEPROM is given. The second column illlustrates data stored at each of the addresses. Third and fourth columns illustrate the control flow for reading of data from the EEPROM for a bi-directional scanner and for a uni-directional scanner, respectively. FIG. 9b illustrates two axes. A first axis illustrates a clock pulse that clocks data out of the EEPROM device. A second axis illustrates a series of “ON” and “OFF” states that correspond to a portion of the bar code sequence that is stored in the EEPROM device, specifically in addresses 100, 101, 102 and 103. The data is stored in successive addresses in memory and is clocked out in a serial fashion. The data at each address represents eight clock cycles and identifies either an “ON” or an “OFF” state in a bitwise fashion. For example, address 102 stores the hexadecimal ox50. The 5, with binary representation 0101, occupies a first four bits and the 0, with binary representation 0000, occupies a second four bits of the memory word. A zero bit corresponds to an “OFF” state and the microprocessor controls the EBCS device to cease emitting light from the light source, simulating light reflected from a bar in a bar code. A one bit corresponds to an “ON” state and the microprocessor controls the EBCS device to drive the light source to emit light, thereby representing light reflected from a space of a bar code. The data stored at address 102 therefore is used by the microprocessor to toggle the light source on and off for four unit durations and then turn it off for four consecutive unit durations, as illustrated in FIG. 9b. Each unit duration corresponds to a minimum width of a bar and a space in a bar code. The unit duration is a function of the frequency of the clock cycle. Accordingly, the clock frequency can be varied to provide simulated bar code sequences of shorter or longer unit durations, thus changing the relative “size” of the simulated signal by the EBCS device so that it appears as expected to a scanner.

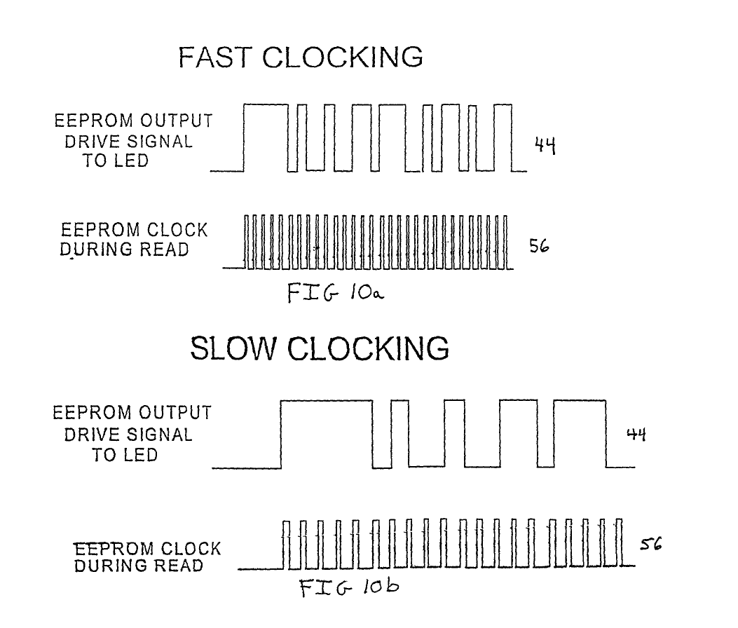

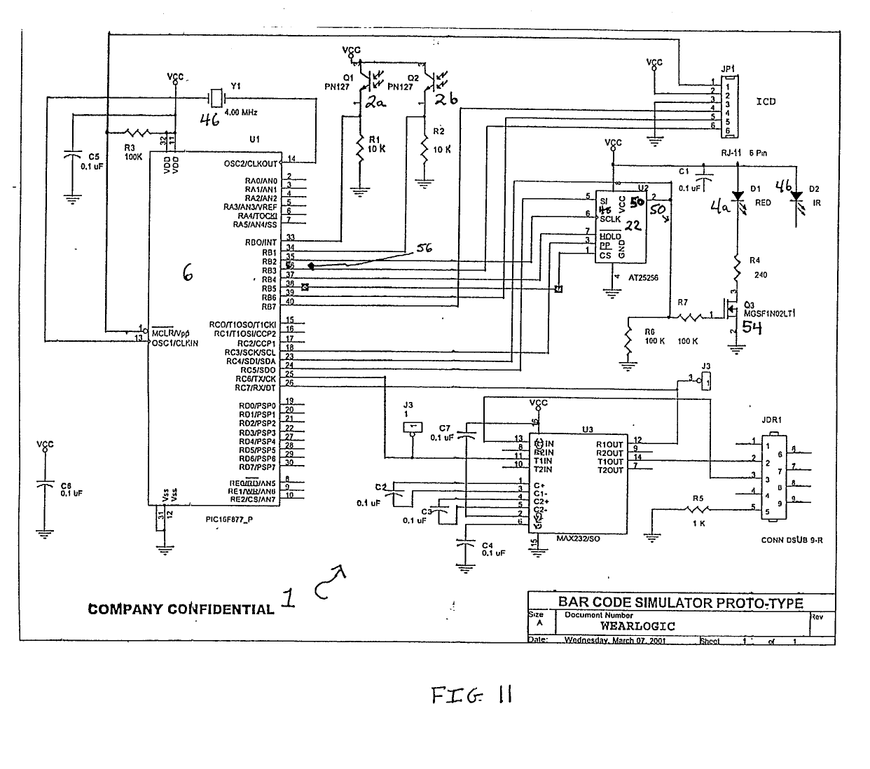

FIGS. 10a and 10b illustrate an exemplary simulated bar code signal 44 that employs a variable frequency clock in order to adjust the “size” of a simulated bar code signal. The sequence of “ON” and “OFF” states is comprised of a predetermined number of unit durations of widths defined as a single clock cycle, i.e., the interval of each “ON” and “OFF” state in a sequence in composed of an integer number of clock cycles. It should be appreciated that the exemplary pattern of the simulated bar code signals illustrated in FIGS. 10a and 10b are identical, but the unit duration, i.e., the clock frequency has been varied in order to adjust the “size” of the simulated bar code signal. In other words, the EBCS device can, in response to detection of a speed of the scanner signal as described herein, provide a simulated bar code signal adjusted in “size” to accommodate the scanner speed by varying the frequency of the clock cycle. With this arrangement, information about a bar code pattern to be simulated can be coded and stored in the memory device and read out at any desirable rate by a variable frequency clock signal so that the “size” of a simulated bar code signal can be adjusted to match the speed of a scanner signal.

FIG. 9a also illustrates one method that some embodiments of the EBCS device may use to generate a forward and a reverse signal for a scanner that is bi-directional. According to some embodiments, each sequence begins and ends with a 16 count “ON” interval that corresponds to the white space or a “quiet zone” that borders all printed bar codes. As illustrated in FIG. 9a, addresses 115 and 116 contain data 0xFF (1111 1111) corresponding to the “quiet zone” at the end of the bar code being simulated by the EBCS device in a forward sequence, and this “quiet zone” is repeated at addresses 117 and 118 for bar code data being simulated in a reverse sequence. Addresses 119-133 store data to simulate the bar code sequence as it would appear if it were simulated in the reverse sequence. It is to be appreciated that bar code data may not exactly fill multiples of a memory word width. For example, in the illustrated sequence stored in the EEPROM of FIG. 9a, the 2 (0010) at address space 114 represents the last piece of data relating to the bar code pattern and the F (1111) is data to pad the sequence with “white space.” Consequently, the 4 (0100) at address 119 is the first piece of data in the reversed stored data sequence, which has a binary representation exactly in reverse of the 2 (0010) at address space 114 in the forward sequence of data. Similarly, the 2 (0010) at address 119 is the reverse of the 4 (0100) at address 113, the B (1011) at address 120 is the reverse of the D (1101) at address 113, etc., such that the simulated bar code signal is also stored in reverse sequence. This reversed stored data sequence allows the EBCS device to simulate the reflected light pattern expected by a bi-directional scanner that alternates the direction with which it traverses a bar code.

The third and fourth columns of FIG. 9a show control flows for operation with bi-directional and uni-directional scanners, respectively, according to some embodiments of the EBCS device. Whenever a uni-directional scanner device is detected by the EBCS device, an address of the beginning of the forward pattern of a bar code sequence is clocked out of memory until the pattern is completely simulated, and the EBCS device then returns to the beginning address of the sequence to begin the process again at the appropriate timing as illustrated in the fourth column of FIG. 9a. Alternatively, whenever a bi-directional scanner is detected, the address of a beginning of the forward pattern of a bar code sequence is clocked out in the same fashion as in the uni-directional case. However, instead of returning to the beginning address, the device then waits at the final address of the forward pattern for an appropriate timing, at which point the device will begin clocking out the reverse pattern as illustrated in the third column of FIG. 9a. With this arrangement, sequences corresponding to a bar code pattern can be stored and generated in the forward and reverse pattern to accommodate both uni-directional and bi-directional scanners.

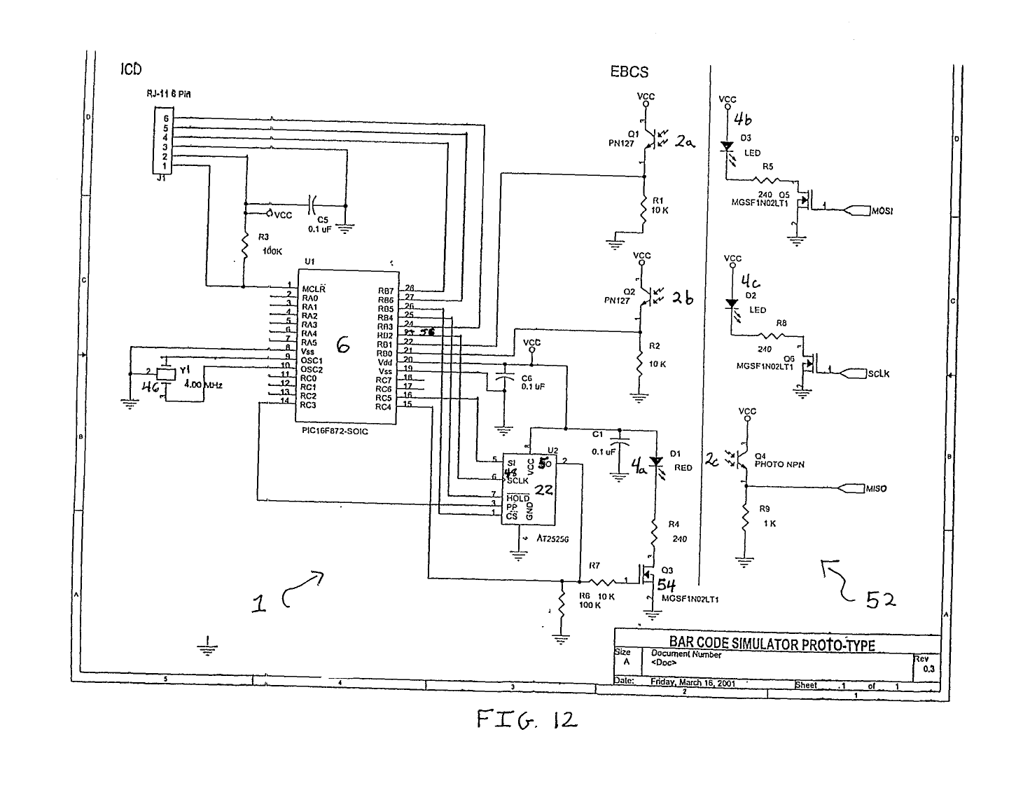

FIG. 11 illustrates a schematic diagram of one embodiment of the ECBS device. Two photo-detectors 2a,b that detect the presence of a bar code scanner signal are coupled to a microprocessor 6. The microprocessor is coupled to an EEPROM device 22 that stores sequences corresponding to simulated bar code signals as described in conjunction with FIG. 10. The EEPROM device is coupled to a pair of LEDs 4a,b through a MOSFET (Metal Oxide Semiconductor Field Effect Transistor) 54. The microprocessor 6 is coupled to a clock signal 46 and is capable of internally synthesizing a variable frequency clock signal from clock signal generator 46 and providing the variable frequency clock signal on signal line 56. The microprocessor provides the clock signal at a selected frequency to a clock input 48 of the EEPROM device in order to clock out the stored sequences in a serial fashion as described in conjunction with FIGS. 9a and 9b. The data is clocked out of memory in a serial bitstream, a singe bit at a time. It is desirable that the rising and falling edges of a signal driving the LEDs maintain as square a shape as possible to reduce the transition time between LED “ON” and “OFF” states, even at high frequency signal transitions. To achieve this the output 50 from the EEPROM device is coupled to a MOSFET 54 capable of providing driving signals with the edge integrity to drive the LEDs such that the emitted signal properly simulates the light pattern reflected from a bar code. According to some embodiments of the EBCS device, the microprocessor is programmed to vary the frequency of the synthesized clock signal applied to the EEPROM according to the speed of a scanner signal detected by any of the methods discussed herein and can be configured according to any other method that is apparent to one of skill in the art. The microprocessor can also be programmed to instruct the EEPROM to clock out sequences and reverse sequences, as discussed in conjunction with FIG. 9a, dependent upon whether a uni-directional or bi-directional type scanner has been detected by any of the methods described herein, and can be configured according to any other method that is readily apparent to one of skill in the art.

FIG. 12 illustrates another embodiment of the EBCS device according to the present invention. This embodiment comprises many of the same components as the embodiment of FIG. 11, including the photo-detectors 2a,b coupled to a microprocessor 6, the EEPROM device 22 coupled to one LED 4a through a MOSFET driver 54. The description of the operation of these components is therefore not repeated and it is to be understood that this embodiment of the EBCS also comprises a docking station 52. The docking station allows bar code sequences to be transferred to or downloaded from an associated computer. The docking station includes two LEDs 4b,c that are disposed within the docking station such that they are in alignment with the photo-detectors 2a,b of the EBCS device in order to be able to communicate with the photo-detectors when the EBCS device is connected to the docking station. The docking station further includes a photo-detector 2c disposed within the docking station in alignment with the LED 4a of the EBCS device when the EBCS device is connected to the docking station, which can detect simulated bar code signals emitted by the EBCS device. The docking station may also include a serial or parallel port connection to allow communication with a PC or other associated computer. According to some embodiments of the EBCS device, the microprocessor 6 can be configured to store incoming bar code signals as sequences in the EEPROM device, when the EBCS device is attached to the docking station. With this arrangement, bar codes can be transferred to a computer from the EBCS device, or downloaded from a computer to the EBCS device.

One embodiment of an EBCS and storage device is illustrated in FIG. 13, which is an Electronic Coupon Holder (ECH) 24. The ECH is preferably credit card sized, but can be constructed to any suitable size and shape. The ECH has a front face to which the bar code simulator components can be affixed, including a photo-detector 2 mounted in vertical alignment with a light source 4. It is to be understood that all embodiments of the bar code simulator device and components discussed herein, and any variations or modification apparent to one of skill in the art can be used in the ECH device. Some embodiments of the ECH may contain a micro-controller, a memory that stores bar code pattern sequences, and detection circuitry coupled to the microcontroller to determine scanner operating characteristics. The ECH may also comprise a scanner tip 26 that can emit a scanning signal and detect reflected light patterns, for example, from a bar code printed on a coupon. According to some embodiments, the scanner tip can be mounted to a comer of the ECH device. Thus, some embodiments or the ECH comprise the scanner tip coupled to the memory such that bar codes read by the scanning tip can be stored in memory, and that can later be simulated as reflected bar codes by the ECH.

According to some embodiments of the ECH, the memory additionally stores a user interface program, and an LCD display 28 and keypads 30 are mounted on the front face so that a user of the ECH can interact with the ECH device via the user interface program stored in memory and via the keypads. With this arrangement, a user can, for example, display any coupons stored on the device, select a coupon to be simulated by the ECH, delete any coupons and enact any desired function related to scanning a coupon, storing a coupon, displaying a coupon and simulating coupon data with the ECH device. In addition, some embodiments of the ECH can be configured such that when the ECH device detects out-of-date coupon data, it can be programmed to automatically delete it. Accordingly, a scanner can access the ECH device, and the ECH device can present coupons that is has stored to the scanner. In addition, according to some embodiments of the ECH device, it may also be possible to use the bar code scanner tip to scan products and to have the ECH display what coupons it has for that product.

It is to be appreciated that although the bar code simulator has been illustrated, for example, as an ECH, the bar code simulator and storage device may be used in other ways and has numerous applications, as will be readily apparent to those of skill in the art. For example, one application is an Infrared Data Association (IrDA) interface for communicating, for example, with another computer. For example, it may be possible to have each EBCS device transmit data, such as customer data to the store computer according to the above described procedure for simulating data with the infrared light source. Thus, the bar code simulator and storage device according to the present invention is suitable for any application where the reading, storing, and simulating of bar codes and transferring of data in the form of a bar code is desirable.

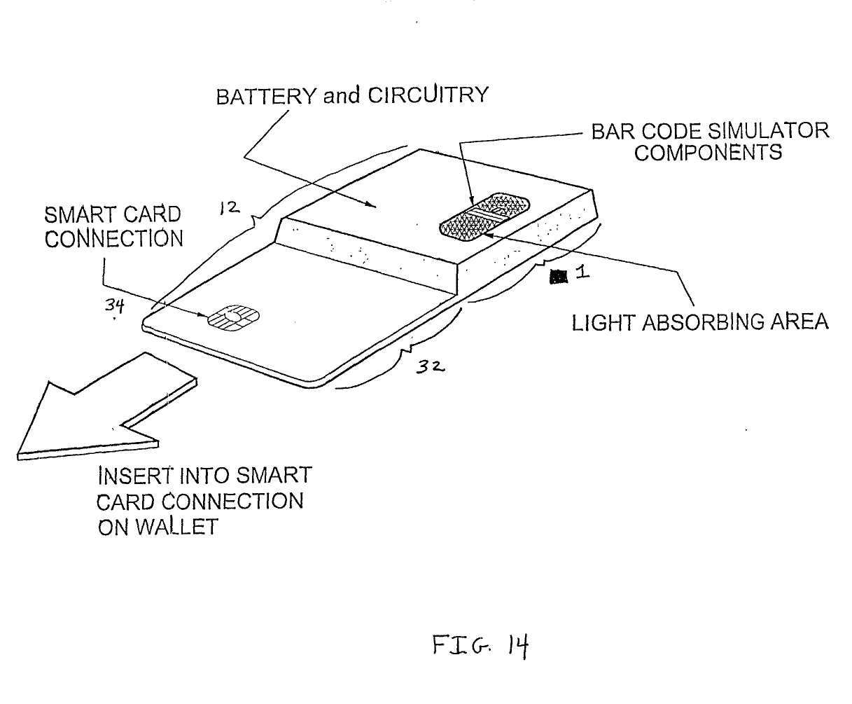

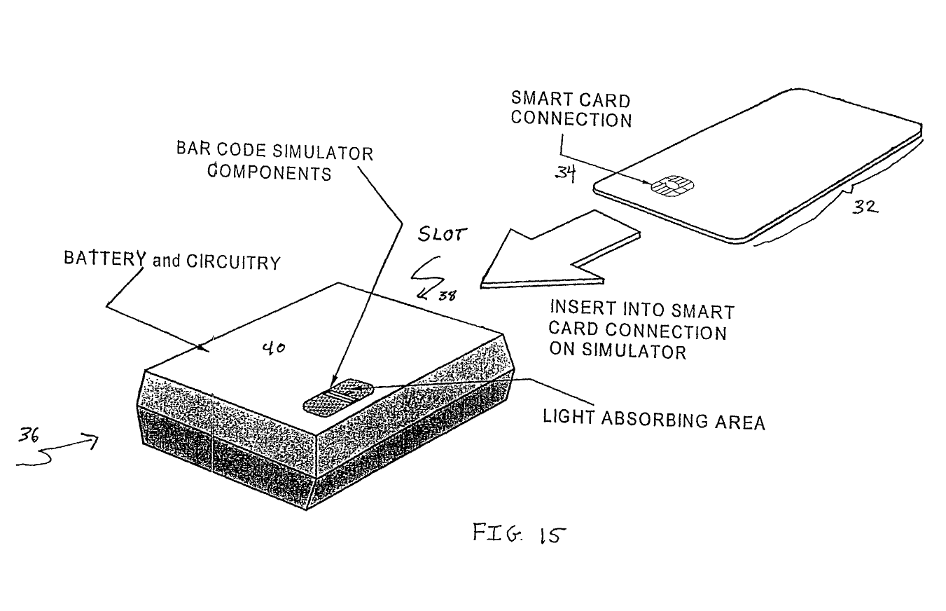

Referring to FIG. 14, there is illustrated one embodiment of an EBCS that comprises a smart card form factor 32 external interface. For example, a smart card interface 34 may be built into a surface of a printed circuit board 12 on which the EBCS 100 is manufactured. With this arrangement, an EBCS card may then be inserted into a smart card adapter port which is coupled to a computing device to communicate with the computing device through the smart card interface. One embodiment of a computing device may comprise a flexible circuit assembly that is incorporated into an electronic wallet, as disclosed in U.S. application Ser. No. 09/259,937, herein incorporated by reference, which may have a smart card connection that can be used to interface the electronic wallet to the EBCS device of FIG. 14.

FIG. 15 illustrates an embodiment of a smart card to bar code simulator device 36 that can comprise any of the embodiments of the EBCS device described herein. As illustrated in FIG. 15, the device includes a slot 38 that allows insertion of a smart card into the device and also contains smart card reading circuitry (not illustrated) to read the smart card. The device can be provided with structure to indicate whether the smart card has been correctly inserted into the reader slot, such as two LEDs. For example, an LED that lights up green when the smart card is correctly inserted into the reader slot and at least one LED that lights up red when the smart card is not correctly inserted into the reader slot. On the face 40 of the smart card to bar code simulator device, any of the herein described EBCS components can be mounted. It should be appreciated that any of the herein described variations and alternative components can be used. Furthermore, the device can contain the detection circuitry and logic herein described, and with this arrangement can detect scanner operating characteristics and modify an emitted signal so that the smart card to bar code simulator device can work with any scanner. The device may also include a battery or appropriate line cord for appropriate voltage (e.g., 120 VAC) to power the device and the EBCS components and circuitry.

It is to be appreciated that the smart card to bar code device as described can be used as an interface between existing pervasive bar code technology infrastructure and smart card technology. This device can be used, for example, to simulate in the form of a bar code any coupons, discounts, special offers and the like that have been stored on a smart card, debit card, credit card or any card. The smart card to bar code device can simulate a bar code in the manner described herein so that the bar code can be detected by any of the existing scanners that exist at point-of-sale locations, or any location configured to scan bar codes. For example, the smart card to bar code simulator device can be used at a bank, a hospital, to read information stored on a smart card or credit card type device. One advantage of this embodiment is that point-of-sale, bank, and other locations need not update infrastructure, which can be expensive, with smart card reading devices. Instead, these locations can be provided with a smart card to bar code simulating device, which will interface any smart card type device to already existing bar code scanning technology.

In addition, some embodiments of the device can be configured to operate with certain bank issued cards, specific code branded cards, and the like. With this arrangement, the device can be used in a plurality of ways, such as: if such an issuer's card is used at a specific merchant, the card holder can receive a discount, an additional product, an extra service, and the like; if a specific type of card is used, the card holder can receive instant values from the card issuer at a participating merchant; and if a card holder shops at a participating merchant with such a card, the card holder could win a range of prizes including, for example, cash back, discounts, products, services and the like.

It is to be understood that the smart card to bar code simulator device can be installed, for example, at a check out counter at a point of sale location. It is also to be appreciated that the device can be made easy to install, and can be made to operate on batteries or a line cord connection, and need not have a network connection. In addition, it is contemplated that the device can be branded by the merchant, or by the merchant and a card company together so as to act as a billboard or platform for advertising at a point of sale merchant. Moreover, it is to be understood that the device as herein described will be easy to use, and can be made easy to program and thereby operable with very little training of personnel. In particular, the device can be configured to indicate whether the smart card has been correctly or incorrectly inserted into the card reader slot. Once a smart card has been correctly inserted into the device, a sales person can point a bar code scanner at the device to capture the electronic bar code data stored on the smart card. The card holder can then use the smart card in a standard manner to pay for the product, or can pay by any other acceptable mechanism allowed by the merchant.

Having thus described certain embodiments of the present invention, various alterations, modifications and improvements will be apparent to those of ordinary skill in the art. Such alterations, variations and improvements are intended to be within the spirit and scope of the present invention. Accordingly, the foregoing description is by way of example and is not intended to be limiting. The present invention is limited only as defined in the following claims and the equivalents thereto.

What is claimed is:

1. A method of generating a bar code signal that simulates light reflected from a bar code, comprising the acts of:
detecting a bar code scanner signal to provide a detected bar code scanner signal;
providing a bar code signal having a first state that corresponds to a bar of a bar code and a second state that corresponds to a space of the bar code;
providing the bar code signal with a sequence of the first state of the bar code signal and the second state of the bar code signal to simulate light reflected from the bar code; and
detecting a scanning speed of the bar code scanner signal.

2. The method as claimed in claim 1, wherein the act of providing the bar code signal comprises providing each of the first state and the second state in the sequence with a duration corresponding to a width of the bar and a width of the space in the bar code.

3. The method as claimed in claim 2, wherein the act of providing the bar code signal further comprises adjusting the duration of each of the first state and the second state in the sequence according to the detected scanning speed of the bar code scanner signal.

4. The method as claimed in claim 3, wherein the act of providing the bar code signal comprises generating a clock signal having a clock cycle.

5. The method as claimed in claim 4, wherein the act of providing each of the first state and the second state with the duration comprises providing the duration as an integer number of clock cycles of the clock signal.

6. The method as claimed in claim 5, wherein the act of adjusting the duration comprises varying a frequency of the clock signal.

7. The method as claimed in claim 1, wherein the act of detecting the scanning speed of the bar code scanner signal comprises measuring a delay interval between two detected signals.

8. The method as claimed in claim 1, wherein the act of detecting the scanning speed of the bar code scanner signal comprises measuring a width of the detected bar code scanner signal.

9. The method as claimed in claim 1, further comprising an act of determining whether the bar code scanner signal is from a uni-directional bar code scanner or a bi-directional bar code scanner.

10. The method as claimed in claim 9, wherein the act of determining comprises determining a temporal order in which the bar code scanner signal is detected by two detectors.

11. The method as claimed in claim 1, further comprising an act of predicting a timing between successive pulses of the bar code scanner signal to provide predicted timings of the bar code scanner signal.

12. The method according to claim 11, wherein the act of providing the bar code signal comprises providing the bar code signal at the predicted timings of the bar code scanner signal.

13. A method of generating a bar code signal that simulates light reflected from a bar code, comprising the acts of:
detecting a bar code scanner signal to provide a detected bar code scanner signal;
providing a bar code signal having a first state that corresponds to a bar of a bar code and a second state that corresponds to a space of the bar code;
providing the bar code signal with a sequence of the first state of the bar code signal and the second state of the bar code signal to simulate light reflected from the bar code; and
determining whether the bar code scanner signal is from a uni-directional bar code scanner or a bi-directional bar code scanner.

14. The method as claimed in claim 13, wherein the act of determining comprises determining a temporal order in which the bar code scanner signal is detected by two detectors.

15. The method as claimed in claim 13, wherein the act of providing the bar code signal comprises providing each of the first state and the second state in the sequence with a duration corresponding to a width of the bar and a width of the space in the bar code.

16. The method as claimed in claim 15, further comprising the act of detecting a scanning speed of the bar code scanner signal.

17. The method as claimed in claim 16, wherein the act of providing the bar code signal further comprises adjusting the duration of each of the first state and the second state in the sequence according to the detected scanning speed of the bar code scanner signal.

18. The method as claimed in claim 17, wherein the act of providing the bar code signal comprises generating a clock signal having a clock cycle.

19. The method as claimed in claim 18, wherein the act of providing each of the first state and the second state with the duration comprises providing the duration as an integer number of clock cycles of the clock signal.

20. The method as claimed in claim 19, wherein the act of adjusting the duration comprises varying a frequency of the clock signal.

21. The method as claimed in claim 16, wherein the act of detecting the scanning speed of the bar code scanner signal comprises measuring a delay interval between two detected signals.

22. The method as claimed in claim 16, wherein the act of detecting the scanning speed of the bar code signal comprises measuring a width of the detected bar code scanner signal.

23. A bar code simulator device that generates a bar code signal that emulates a light pattern reflected from a bar code, comprising:
at least one light source that emits a coded light signal having a first state that corresponds to light reflected from a bar of the bar code and a second state that corresponds to light reflected from a space of the bar code;
a controller that controls the at least one light source to provide the coded light signal with a sequence of the first state of the bar code signal and the second state of the bar code signal to simulate the light pattern reflected from the bar code;
at least one detector that detects a bar code scanner signal to provide a detected bar code scanner signal; and
detection circuitry coupled to the at least one detector that determines a scanning speed of the bar code scanner signal.

24. The bar code simulator device as claimed in claim 23, wherein the detection circuitry determines the speed of the bar code scanner signal by determining a width of the detected bar code scanner signal.

25. The bar code simulator device as claimed in claim 23, wherein the at least one detector comprises first and second detectors that provide respective first and second detected bar code scanner signals.

26. The bar code simulator device as claimed in claim 25, wherein the detection circuitry determines the scanning speed by determining a delay interval between the first and second detected bar code scanner signals.

27. The bar code simulator device as claimed in claim 25, further comprising a light barrier that separates the first and second detectors.

28. The bar code simulator device as claimed in claim 23, further comprising a light pipe that is light coupled to the at least one detector.

29. The bar code simulator device as claimed in 23, wherein the controller controls the at least one light source to provide the coded light signal with the first state and the second state having a duration corresponding to a width of the bar and a width of the space in the bar code respectively.

30. The bar code simulator device as claimed in 29, wherein the controller adjusts the duration of each of the first state and the second state in the sequence according to the detected scanning speed of the bar code scanner signal.

31. The bar code simulator device as claimed in claim 30, wherein the controller comprises a clock signal generator that generates a variable frequency clock signal having a clock cycle, that is coupled to the at least one light source to emit the coded light signal.

32. The bar code simulator device as claimed in claim 31, wherein the controller controls the at least one light source to provide the duration of each of the first state and the second state as an integer number of clock cycles of the clock signal.

33. The bar code simulator device as claimed in claim 32, wherein the controller controls the clock signal generator to vary a frequency of the clock signal to adjust the duration of each of the first state and the second state according to the scanning speed of the detected bar code scanner signal.

34. The bar code simulator device as claimed in claim 31, wherein the controller comprises a driver coupled to the at least one light source and to the clock signal generator, that drive s the at least one light source.

35. The bar code simulator device as claimed in claim 23, further comprising a light diffuser coupled to the at least one light source, that diffuses the emitted coded light signal.

36. The bar code simulator device as claimed in claim 23, wherein the at least one light source comprises an infrared light source that emits light in an infrared frequency band.

37. The bar code simulator device as claimed in claim 23, wherein the at least one light source comprises a visible light source that emits light in a visible frequency band.

38. The bar code simulator device as claimed in claim 23, wherein the at least one light source comprises an infrared light source that emits light in an infrared frequency band and a visible light source that emits light in a visible frequency band.

39. The bar code simulator device as claimed in claim 38, wherein the detection circuitry comprises at least one detector having a detection frequency band of the bar code scanner signal, and wherein in response to detection of the detection frequency band of the bar code scanner signal, the controller controls the at least one light source to emit the coded light signal at the frequency band that corresponds to the detection frequency band of the bar code scanner signal.

40. The bar code simulator device as claimed in claim 23, further comprising a light absorbing area, and wherein the at least one detector and the at least one light source are located within the light absorbing area.

41. The bar code simulator device as claimed in claim 23, wherein the at least one detector and the at least one light source are disposed in close proximity and in substantially vertical alignment.

42. The bar code simulator device as claimed in claim 23, wherein the detection circuitry comprises an automatic gain control device coupled to the at least one detector, that automatically adjusts its gain to accommodate ambient light conditions and an intensity of the detected bar code scanner signal.

43. The bar code simulator device as claimed in claim 23, further comprising a light pipe coupled to the at least one photo-detector that comprises a first portion constructed with a material having a first opacity and a second portion constructed with a material having a second opacity, that focuses the bar code scanner signal on the at least one detector such that a step signal detected bar code scanner signal is provided by the at least one detector.

44. The bar code simulator device as claimed in claim 43, wherein the detection circuitry comprises a threshold detector that determines if the step signal detected bar code scanner signal is above a certain threshold and provides a threshold detector signal, and wherein the detection circuitry determines from the threshold detector signal whether a bar code scanner that provided the bar code scanner signal is a uni-directional type bar code scanner or a bi-directional bar code scanner.

45. The bar code simulator device as claimed in claim 23, wherein the detection circuitry determines an interval between successive pulses of the detected bar code scanner signal.

46. The bar code simulator device as claimed in claim 45, wherein the detection circuitry determines a predicted timing of a subsequent detected bar code scanner signal from the interval between detected bar code scanner signals, and wherein the controller controls the bar code simulator device to provide successive coded light signals to correspond with the predicted timing.

47. The bar code simulator device as claimed in claim 23, further comprising a memory device that stores at least one simulated bar code sequence.

48. The bar code simulator device as claimed in claim 47, wherein the memory further comprises a user interface program.

49. The bar code simulator device as claimed in claim 48, wherein the memory is coupled to the controller that executes the user interface program.

50. The bar code simulator device as claimed in claim 49, further comprising a display.

51. The bar code simulator device as claimed in claim 50, further comprising at least one input device that is coupled to the controller, and wherein the controller is configured to interact with the at least one input device.

52. The bar code simulator device as claimed in claim 51, wherein the controller is further configured such that the contents of the memory can be browsed, displayed, or selected by the at least one input device.

53. The bar code simulator device as claimed in claim 23, further comprising a scanner that emits the bar code scanner signal, and that comprises a detector that detects the emitted coded light signal.

54. The bar code simulator device as claimed in claim 23, further comprising:
a housing having a slot that accommodates insertion of a smart card device and having a surface to which is attached the at least one detector and the at least one light source, the housing containing the detection circuitry, the controller, smart card reading circuitry that reads information from the smart card device, and a processor coupled to the smart card circuitry and to the at least one light source to comprise a smart card to bar code simulating device that reads the smart card device and emits the coded light signal coded with the data from the smart card device.

55. The smart card to bar code simulating device as claimed in claim 54, further comprising an indicating device that indicates whether a smart card has properly been inserted into the slot.

56. The smart card to bar code simulating device as claimed in claim 55, wherein the indicating device comprises at least one light emitting diode.

57. The bar code simulating device as claimed in claim 23, further comprising:
a housing to which is attached the at least one detector and the at least one light source, the housing comprising the detection circuitry and the controller, and having a portion shaped and arranged in the shape of a smart card.
